(19) United States
(12) Patent Application Publication
(10) Pub. No.: US 2018/0042270 A1
(43) Pub. Date: Feb. 15, 2018

(54) METHOD OF PRODUCING PET FOOD

(71) Applicants: Unicharm Corporation, Ehime (JP); Kyushu Petfood Co., Ltd., Fukuoka (JP)

(72) Inventors: Masaki ICHIHASHI, Itami-shi (JP); Yosuke KOBAYASHI, Itami-shi (JP); Kentarou KIYA, Kasuya-gun (JP)

(21) Appl. No.: 15/557,171

(22) PCT Filed: Mar. 7, 2016
(86) PCT No.: PCT/JP2016/056968

§ 371 Date: Sep. 11, 2017

(30) Foreign Application Priority Data
Mar. 13, 2015 (JP) 2015-051467

(51) Int. Cl. A23K 50/45; A23K 40/25

(52) U.S. Cl. CPC A23K 50/45; A23K 40/25

(57) ABSTRACT

Provided is a method of producing pet food including: a process of heating and foaming dough into which an expanding agent, a preservative, and a pH adjusting agent are mixed to produce food granules containing animal-derived raw ingredients and having a crude protein content of 10% to 35% by mass, a moisture content of 20% to 35% by mass, and a pH of 6.5 or less.

### TECHNICAL FIELD

The present invention relates to a method of producing pet food.

Priority is claimed on Japanese Patent Application No. 2015-051467, filed on Mar. 13, 2015, the content of which is incorporated herein by reference.

### BACKGROUND ART

Pet food that contains a large amount of meat such as chicken breast jerky or beef jerky has high palatability for pets and is highly popular as pet food for snack.

PTL 1 describes an example in which jerky for pets is produced by heating, drying, and forming jerky dough, which contains a large amount of meat (chicken breast and chicken meat), starch, and vital gluten and to which a small amount of water is added, using a forming machine, bringing the dough into contact with a heating roller to form meshes on the dough, and cooling the resulting dough.

### CITATION LIST

### Patent Literature

[PTL 1] Japanese Unexamined Patent Application, First Publication No. 2013-118867

### SUMMARY OF INVENTION

### Technical Problem

However, since the jerky for pets described in PTL 1 contains a large amount of proteins and a small amount of moisture, the jerky has excellent storability, but is hard and does not taste good.

An object of the present invention is to provide a method of producing pet food which contains a large amount of proteins and has a soft texture and excellent storability.

### Solution to Problem

An embodiment of the present invention is as follows.

[1] A method of producing pet food including: a process of heating and foaming dough into which an expanding agent, a preservative, and a pH adjusting agent are mixed to produce food granules containing animal-derived raw ingredients and having a crude protein content of 10% to 35% by mass, a moisture content of 20% to 35% by mass, and a pH of 6.5 or less.

[2] The method of producing pet food according to [1], in which the preservative contains sorbic acid and/or potassium sorbate.

[3] The method of producing pet food according to [1] or [2], in which the pH adjusting agent is in the form of granules, and the granules being an acid component which is in a solid state at room temperature being coated with fats and oils which are in a solid state at room temperature.

[4] The method of producing pet food according to any one of [1] to [3], in which the content of the expanding agent is in a range of 1% to 4% by mass based on the total amount of raw ingredients in the dough.

[5] The method of producing pet food according to any one of [1] to [4], in which the dough contains cereals, and the content of the cereals is in a range of 6% to 44% by mass based on the total amount of raw ingredients in the dough.

[6] The method of producing pet food according to any one of [1] to [5], in which alginic acid ester is further mixed into the dough.

### Advantageous Effects of Invention

According to the present invention, it is possible to produce pet food which contains a large amount of proteins and has a soft texture and excellent storability.

### DESCRIPTION OF EMBODIMENTS

### Food Granules

Pet food of the present embodiment has a granular shape and is referred to as a food granule in a case of indicating each granule. The pet food of the present embodiment is an aggregate of food granules.

### Moisture Content in Product

In the present specification, the moisture content in a pet food product (moisture content in food granules) is a value obtained by the following measurement method.

An object to be measured is ground using a grinder by passing the object through a sieve having a size of 1 mm, and then the object is used as an analytical sample. 2 to 5 g of the analytical sample is accurately weighed, put into an aluminum weighing dish (after the sample has been dried in advance, the weight thereof is accurately weighed), dried at a temperature of 135±2° C. for 2 hours, and left to be cooled in a desiccator. Next, the weight thereof is accurately weighed, and then the moisture content is acquired from a difference between the weights weighed before and after the drying.

In the present specification, the moisture content of the pet food product is a value obtained by measurement immediately after a pet food product produced by heating and foaming dough, cooling the dough at room temperature, storing the resultant in a packaging container, and sealing the packaging container has been opened within 30 days from the date of manufacture or is a value obtained by measurement under the conditions similar to the conditions described above.

### Crude Protein Content

In the present specification, the value of the crude protein content in the pet food (crude protein content in food granules) is obtained by measurement using a Kjeldahl method. Specifically, the crude protein content is calculated by multiplying the nitrogen content (unit %) measured using a Kjeldahl method by 6.25 as a protein coefficient.

According to the present method, the total content of amino acids and aminos other than pure proteins is measured as the crude protein content.

### Raw Ingredients

The pet food of the present embodiment is obtained by heating and foaming dough containing animal-derived raw ingredients, cereals, an expanding agent, a preservative, and a pH adjusting agent.

### Animal-Derived Raw Ingredients

Examples of the animal-derived raw ingredients include meat (including internal organs) derived from animals (such as fish and domestic animals such as cattle, pig, and chicken), a meat protein decomposed product (digest), and eggs. These may be used alone or in combination of two or more kinds thereof. It is preferable to use at least meat.

From the viewpoint that the palatability of pets is further improved, it is particularly preferable that meat which has not been subjected to a heat treatment is used as the above-described meat.

The total amount of the animal-derived raw ingredients is preferably in a range of 10% to 50% by mass, more preferably in a range of 30% to 50% by mass, and still more preferably in a range of 40% to 50% by mass based on the total amount of raw ingredients (not including added water, the same applies hereinafter) in the dough. When the total amount of the animal-derived raw ingredients is greater than or equal to the lower limit thereof, excellent palatability is easily obtained. When the total amount of the animal-derived raw ingredients is less than or equal to the upper limit thereof, a porous structure formed by foaming is easily obtained.

From the viewpoint of easily obtaining excellent palatability, it is preferable that the raw ingredient whose amount to be mixed (on a mass basis), as a single raw ingredient, is the largest is meat among raw ingredients used for the preparation of dough.

Such pet food containing a large amount of meat is desirable particularly as pet food for snack.

### Expanding Agent

The expanding agent is not particularly limited as long as the expanding agent generates gas when heated, and a known expanding agent can be used. Preferred examples of the known expanding agent include sodium bicarbonate (sodium hydrogen carbonate) and baking powder. Baking powder is a composition which optionally contains alum (burnt alum, ammonium alum, or the like) which is a component contributing to expansion in addition to sodium bicarbonate serving as a base and into which plural kinds of auxiliary agents are mixed. Commercially available baking powder can be used as appropriate. Particularly, from the viewpoints that suitable acidity for generating gas and excellent solubility are obtained and adverse effects on taste are less, it is preferable that the baking powder contains monocalcium phosphate and/or L-potassium hydrogen tartrate as an auxiliary agent.

The expression “dough is heated and foamed” means that the expanding agent in the dough is heated to generate gas so that bubbles are formed (foamed) in the dough. The pet food obtained by heating and foaming dough has a porous structure such as bread or sponge.

The amount of the expanding agent to be mixed is preferably in a range of 1% to 4% by mass, more preferably in a range of 1.4% to 3.6% by mass, and still more preferably in a range of 1.8% to 3.2% by mass based on the total amount of raw ingredients in the dough.

In the present embodiment, the amount of the expanding agent to be mixed indicates the total amount of components contributing to expansion. Therefore, in a case where sodium bicarbonate is used alone, the amount of sodium bicarbonate is the amount of the expanding agent. Further, in a case where baking powder containing alum in addition to sodium bicarbonate is used, the total amount of sodium bicarbonate and alum is the amount of the expanding agent.

When the amount of the expanding agent to be mixed is greater than or equal to the lower limit of the above-described range, bubbles are sufficiently formed in the dough. When the amount of the expanding agent to be mixed is less than or equal to the upper limit thereof, the dough is not extremely swollen and thus excellent formability is easily obtained. Further, when the amount of the expanding agent to be mixed is extremely large, the palatability may be decreased.

### Preservative

As a preservative, a material that exhibits effects in an acidic region of a pH of 6.5 or less is used. The preservative can be appropriately selected from known preservatives added to pet food and then used. From the viewpoint of excellent antimicrobial effects, it is preferable to use at least sorbic acid and/or potassium sorbate.

The amount of the preservative to be mixed is set such that desired storability can be obtained. In a case where sorbic acid and/or potassium sorbate is used, the amount of the sorbic acid to be added is preferably in a range of 0.1% to 0.25% by mass, more preferably in a range of 0.15% to 0.25% by mass, and still more preferably in a range of 0.2% to 0.25% by mass based on the total amount of raw ingredients in the dough. When the amount thereof is in the above-described range, the pet food to be obtained is likely to have excellent storability.

### pH Adjusting Agent

As the pH adjusting agent, a known acid component which can be added to pet food can be used. From the viewpoint that an effect of adjusting the pH value is excellent, an organic acid is preferable. It is preferable that the effect of adjusting the pH value is excellent because the amount of the pH adjusting agent to be added which is required to obtain a desired pH value is small and the taste is unlikely to change. Examples of the organic acid include lactic acid, fumaric acid, citric acid, and malic acid. From the viewpoint that the taste of pet food is unlikely to change, lactic acid and/or fumaric acid is preferable.

It is preferable that the pH adjusting agent is contained in the dough by being coated with fats and oils which are in a solid state at room temperature (25° C.) and then formed into a granular shape. Specifically, a pH adjusting agent which is coated with fats and oils and has a granular shape is obtained by forming an acid component, which is in a solid state at room temperature, into a granular shape and then coating the component with fats and oils according to a known method. The granular pH adjusting agent can be selected from commercially available pH adjusting agents. As the fats and oils to be applied, fats and oils which are in a solid state at room temperature and melted at a heating temperature at which the dough is heated and foamed are used. Examples of such fats and oils include hardened oil such as palm oil. Examples of the acid component which is in a solid state at room temperature include fumaric acid, citric acid, and malic acid.

The acid component coated with fats and oils does not come into contact with the components in the dough before being heated and comes into contact with the components in the dough due to the coated layer being melted during the heating. In this manner, generation of gas, caused by a reaction of the expanding agent in the dough with the acid component before the dough is heated and foamed, is prevented and the dough is efficiently and stably foamed during the heating.

The amount of the pH adjusting agent to be mixed is set such that a desired pH value can be obtained. From the viewpoint that the palatability is easily decreased when the acidity is extremely high, the amount of the pH adjusting agent to be mixed is preferably 3% by mass or less and more preferably 1.5% by mass or less based on the total amount of raw ingredients in the dough.

### Cereals

As the cereals, cereals known as raw ingredients of pet food can be used. Examples of the known cereals include corn, wheat, rice, barley, oats, and rye. These may be used alone or in combination of two or more kinds thereof. It is preferable to use at least wheat.

Further, it is preferable that a processed product containing wheat protein is used as a part of cereals in addition to wheat. As such a processed product, a product in which the content of starch is less and the content of proteins is greater than the content of wheat is preferable. Examples of such a product include wheat gluten.

When the dough contains a processed product containing wheat protein, the content of the wheat protein can be increased without increasing the content of starch. The shrinkage of the dough after being swollen by being heated and foamed is suppressed by increasing the content of wheat protein.

The total amount of cereals is preferably in a range of 6% to 44% by mass, more preferably in a range of 11% to 26% by mass, and still more preferably in a range of 14% to 21% by mass based on the total amount of raw ingredients in the dough. When the total amount of cereals is greater than or equal to the lower limit of the above-described range, excellent formability is easily obtained. When the total amount thereof is less than or equal to the upper limit, the palatability is not affected much.

The proportion of the total amount of wheat and the processed product containing wheat protein in the total amount of cereals used for the preparation of the dough is preferably 60% by mass or greater, more preferably 70% by mass or greater, and still more preferably 80% by mass or greater. The proportion thereof may be 100% by mass.

### Other Raw Ingredients

Known raw ingredients used to produce pet food can be mixed into the dough as appropriate in addition to the above-described raw ingredients.

Examples of the known raw ingredients include beans (such as whole soybeans and soybean protein), fats and oils (such as animal fats and oils or vegetable fats and oils), vegetables, powdery additives (such as vitamins, minerals, amino acids, flavoring raw ingredients, fibers, colorants, and palatability enhancers), and liquid additives (such as thickening stabilizers and quality improving agents).

From the viewpoint that food granules tend to be softer, it is preferable that alginic acid ester which is a powdery additive is mixed into the dough.

In a case where alginic acid ester is mixed into the dough, the content of the alginic acid ester is preferably 0.05% by mass or greater, more preferably 0.1% by mass or greater, and still more preferably 0.3% by mass or greater based on the total amount of raw ingredients in the dough. When the content of the alginic acid ester is greater than or equal to the lower limit of the above-described range, the effects of adding the alginic acid ester are sufficiently obtained and softness of food granules is increased. Further, when the content of the alginic acid ester is extremely large, granules tend to be hard. From the viewpoint that granules to be obtained are not extremely hard, the content of the alginic acid ester is preferably 1% by mass or less, more preferably 0.8% by mass or less, and still more preferably 0.6% by mass or less.

### Pet Food

The shape of pet food according to the present embodiment is not particularly limited as long as the shape thereof is suitable for a pet to eat. Examples of the shape of pet food include various granular shapes (such as a pellet shape) and a rod shape (such as a stick shape).

The moisture content of the product of the pet food according to the present embodiment is in a range of 20% to 35% by mass. When the moisture content of the product is in the above-described range, suitable softness is obtained so that the palatability for a pet is improved. Particularly, when the pet food has a porous structure and the moisture content of the product is in the above-described range, excellent elasticity is obtained so that the palatability for a pet is further improved. The moisture content of the product is more preferably in a range of 25% to 30% by mass.

The moisture content of the product can be adjusted according to the moisture content in the dough, the heating conditions for heating the dough, and/or the drying conditions in a case where a drying process is performed.

The crude protein content in the pet food of the present embodiment is preferably in a range of 10% to 35% by mass, more preferably in a range of 15% to 30% by mass, and still more preferably in a range of 20% to 30% by mass. When the content thereof is greater than or equal to the lower limit of the above-described range, excellent palatability is easily obtained. When the content thereof is less than or equal to the upper limit, an excellent porous structure is easily formed through foaming.

In the pet food of the present embodiment, the pH of food granules is 6.5 or less, preferably 6.3 or less, and more preferably 6.0 or less. When the pH is small, antimicrobial power from the preservative is improved. The lower limit of the pH of food granules is not particularly limited, but is preferably 5.0 or greater from the viewpoint of palatability.

In the present specification, the pH of food granules is a value obtained by performing measurement on a suspension formed by grinding food granules and dispersing the ground food granules during deionization such that the concentration thereof is set to 10% by mass using a pH meter. The measurement temperature is room temperature (25° C.).

### Production Method

The pet food of the present embodiment is produced by performing a process of mixing the whole raw ingredients and water (added water) to prepare dough, a process of forming the dough, and a process of heating and foaming the formed product.

A pet food product is obtained by heating and foaming the formed product, performing a drying process on the formed product as necessary, cooling the resultant at room temperature, storing the resultant in a packaging container, and then sealing the container.

The dough may be formed into a desired product shape before the heating and the foaming or formed into a desired product shape by performing primary forming before the heating and the foaming, heating and foaming the dough, and then performing secondary forming of the dough.

For example, the pet food product may have a granular shape or a stick shape, which is a final product shape, by performing extrusion forming (primary forming) on the dough into a string shape, heating and foaming the formed product having a string shape, and then cutting (secondary forming) the formed product to have a predetermined length.

The moisture content in the dough is preferably in a range of 30% to 60% by mass, more preferably in a range of 35% to 55% by mass, and still more preferably in a range of 40% to 50% by mass. When the moisture content in the dough is in the above-described range, excellent formability is easily obtained.

Particularly, in a case where the dough is continuously formed using an extrusion forming machine, it is preferable that the moisture content in the dough is in the above-described range because the dough is hard so that the dough is unlikely to be extruded when the moisture content in the dough is extremely low and the shape of the extruded formed product is not maintained when the moisture content in the dough is extremely large.

Further, dough having a high moisture content of 35% by mass or greater is unlikely to be formed and puffed when a method of producing porous puffed granules using an extruder of the related art is employed, but pet food having an excellent porous structure can be produced according to the present embodiment.

The moisture content in the dough of the present specification indicates the total amount of moisture and added water in the raw ingredients.

It is preferable that the heating conditions for heating and foaming the formed product are set such that a desired foamed state is obtained. When the heating temperature is too low or the heating time is too short, the foaming becomes insufficient and thus an excellent porous structure cannot be obtained. On the contrary, when the heating temperature is too high or the heating time is too long, there is a concern that the dough may be drastically shrunk because the dough is extremely swollen. For example, the heating temperature as the ambient temperature is preferably in a range of 80° C. to 120° C., more preferably in a range of 90° C. to 110° C., and still more preferably in a range of 95° C. to 100° C.

The moisture content of the pet food product can be adjusted to a desired value by performing the drying process after the heating and the foaming.

The drying process can be performed appropriately using a known drying method.

Since the pet food of the present embodiment contains a relatively large amount of moisture and the dough is foamed using an expanding agent during the production of food granules, food granules can be made soft even when the protein content is high. The storability is usually degraded when the moisture content is increased, but by adding a preservative to the pet food of the present embodiment, the storability can be improved.

According to the knowledge of the present inventors, in a case where dough having a particularly high protein content is intended to be foamed using an expanding agent, the foamability is poor if the same amount of expanding agent as an expanding agent which does not contain meat and has a low protein content is used. In contrast, when a large amount of expanding agent is mixed into the dough, the foamability can be improved, but the pH of the dough becomes unstable. Consequently, the effects of the preservative that exhibits effects in an acidic region may not be obtained as designed. In addition, there is a concern that the palatability may be decreased. In other words, it is difficult to achieve both of foamability and storability when the food granules have a particularly high protein content.

In the present embodiment, since an expanding agent, a preservative, and a pH adjusting agent are mixed into the dough, the pH of food granules can be adjusted to be in an acidic region even when a large amount of expanding agent is mixed into the dough. Therefore, food granules can be made soft by obtaining excellent foamability and excellent storability can be also obtained.

### EXAMPLES

Hereinafter, the present invention will be described in detail with reference to the following examples, but the present invention is not limited to these examples.

Main raw ingredients listed in Table 1 are as follows.

Meat: frozen chicken breast, 75% by mass of moisture

Wheat flour: 13% by mass of moisture, 10% by mass of wheat protein

Wheat gluten: 8% by mass of moisture, 75% by mass of wheat protein

Soybean protein: 7% by mass of moisture

Expanding agent a: baking powder, 39% by mass of sodium bicarbonate, 35% by mass of burnt alum, containing monocalcium phosphate, L-potassium hydrogen tartrate, and sucrose fatty acid ester as auxiliary agents

Expanding agent b: baking powder, 28% by mass of sodium bicarbonate, 25% by mass of ammonium alum, containing acidic sodium pyrophosphate, higher fatty acid, and tricalcium phosphate as auxiliary agents

Expanding agent c: baking powder, 27% by mass of sodium bicarbonate, 26% by mass of burnt alum, containing monocalcium phosphate, L-potassium hydrogen tartrate, and glycerin fatty acid ester as auxiliary agents

pH adjusting agent a: fumaric acid coated with fats and oils

pH adjusting agent b: lactic acid

Dextrin: 7% by mass of moisture

Trehalose: 1.5% by mass of moisture

### Reference Example 1 and Examples 1 to 10

Reference Example 1 is an example of producing pet food having a low moisture content in the pet food product without using an expanding agent. Examples 1 to 10 are application examples.

First, doughs were prepared by adding raw ingredients with the formulations listed in Table 1 and water (added water), and mixing the mixtures. The amounts of added water were adjusted such that the doughs had the same level of softness. The mixing ratios listed in Table 1 indicate ratios (unit: part by mass) based on the total amount of raw ingredients that do not contain added water.

Next, the doughs were extruded from a nozzle, formed into a long square string shape (approximately square whose cross section had a side having a length of approximately 7 mm), heated, and foamed. The doughs were heated under an ambient temperature condition of 90° C. for 40 minutes.

Next, the food granules after the heating and the foaming were rapidly cooled by applying cool air thereto. After the food granules were cooled, a granular shape was obtained by cutting the materials in a square string shape at every length of approximately 10 mm.

Further, granular pet food was obtained by heating and drying the resulting granules at an ambient temperature of 65° C. for 20 to 30 minutes.

The formulation of Example 6 was obtained by adding 0.42 parts by mass of alginic acid ester to the formation of Example 7.

### Evaluation

The hardness of the obtained pet food (food granules) was measured according to the following method. The values of hardnesses in each example were listed, as relative values, in Table 1 by setting the hardness of food granules of Reference Example 1 to 100.

Food granules were placed on a flat dish of a compression tester (TEXTURE ANALYZER, model No: EZ-SX, manufactured by Shimadzu Corporation), the food granules were pressed with a screwdriver type plunger and compressed at a constant compression rate (60 mm/min), and the stresses were measured until the thickness of the plunger became 50% of the initial thickness. The hardnesses were compared to each other by comparing the peak values (maximum values) of the obtained stresses. This means that the hardness increases as the peak value becomes higher.

TABLE 1

| | | | Reference | | | | | |
|---|---|---|---|---|---|---|---|---|
| | | | Example 1 | Example 1 | Example 2 | Example 3 | Example 4 | Example 5 |
| Formulation | Animal-derived raw | Meat | 44.5 | 43.0 | 43.0 | 43.0 | 43.0 | 43.0 |
| of raw | ingredients | | | | | | | |
| ingredients | Cereals | Wheat flour | 13.3 | 12.9 | 13 | 13 | 13 | 13 |
| [parts by | | Gluten | 0 | 2.6 | 2.5 | 2.5 | 2.5 | 2.5 |
| mass] | Beans | Soybean protein | 4.4 | 4.3 | 4.0 | 4.0 | 4.0 | 4.0 |
| | Fats and oils | Crude beef tallow and | 3.7 | 3.6 | 4.2 | 4.2 | 4.2 | 4.2 |
| | | the like | | | | | | |
| | Liquid raw ingredients | Thickening stabilizer | 13.5 | 17.4 | 17.5 | 17.5 | 17.5 | 17.5 |
| | | Quality improving | 3.7 | 3.5 | 3.5 | 3.5 | 3.5 | 3.5 |
| | | agent | | | | | | |
| | Expanding agent | Expanding agent a | 0 | 3.4 | 3.5 | 0 | 0 | 3.5 |
| | | Expanding agent b | 0 | 0 | 0 | 3.5 | 0 | 0 |
| | | Expanding agent c | 0 | 0 | 0 | 0 | 3.5 | 0 |
| | pH adjusting agent | pH adjusting agent a | 0 | 1.1 | 1.1 | 0 | 0 | 0 |
| | | pH adjusting agent b | 0 | 0 | 0 | 0.9 | 0.9 | 0.9 |
| | Preservative | Sorbic acid | 0.2 | 0.2 | 0.2 | 0.2 | 0.2 | 0.2 |

| | Dextrin | 0 | 0.5 | 0 | 0 | 0 | 0.5 |
|---|---|---|---|---|---|---|---|
| | Trehalose | 1.8 | 1.7 | 1.7 | 1.7 | 1.7 | 1.7 |
| | Alginic acid ester | 0 | 0.4 | 0.42 | 0.42 | 0.42 | 0.42 |
| | Raw gelatin | 9 | 0 | 0 | 0 | 0 | 0 |
| | Other solid raw ingredients | 6.0 | 5.4 | 5.0 | 5.0 | 5.0 | 5.0 |
| | Total amount of raw ingredients | 100.0 | 100.0 | 99.6 | 99.4 | 99.4 | 99.9 |
| | Total moisture content in raw ingredients | 45.2 | 37.1 | 37.1 | 37.1 | 37.1 | 37.1 |
| Expanding agents in raw ingredients [% by mass] | | 0 | 2.52 | 2.60 | 1.87 | 1.87 | 2.59 |
| Cereals in raw ingredients [% by mass] | | 13.3 | 15.5 | 15.6 | 15.6 | 15.6 | 15.5 |
| Dough | Moisture content in dough [% by mass] | 43 to 47 | | | | | |
| Pet food | Moisture content in product [% by mass] | 28 to 29 | | | | | |
| | Crude protein content [% by mass] | Approx- | Approx- | Approx- | Approx- | Approx- | Approx- |
| | | imately | imately | imately | imately | imately | imately |
| | | 24 | 24 | 24 | 24 | 24 | 24 |
| | pH of food granules | 6.4 | 5.0 to 5.5 | | | | |
| | Evaluation (hardness) | 100 | Approx- | Approx- | Approx- | Approx- | Approx- |
| | | (reference) | imately | imately | imately | imately | imately |
| | | | 45 | 45 | 50 | 50 | 50 |

| | | | | | | | Example |
|---|---|---|---|---|---|---|---|
| | | | Example 6 | Example 7 | Example 8 | Example 9 | 10 |
| Formulation | Animal-derived raw | Meat | 43.0 | 43.0 | 43.0 | 34.0 | 36.5 |
| of raw | ingredients | | | | | | |
| ingredients | Cereals | Wheat flour | 13 | 13 | 13 | 13 | 18 |
| [parts by | | Gluten | 2.5 | 2.5 | 0 | 0 | 0 |
| mass] | Beans | Soybean protein | 4.0 | 4.0 | 4.0 | 4.0 | 3.5 |
| | Fats and oils | Crude beef tallow and | 4.2 | 4.2 | 4.2 | 4.2 | 3.6 |
| | | the like | | | | | |
| | Liquid raw ingredients | Thickening stabilizer | 17.5 | 17.5 | 17.5 | 17.5 | 15.0 |
| | | Quality improving | 3.5 | 3.5 | 3.5 | 3.5 | 3.0 |
| | | agent | | | | | |
| | Expanding agent | Expanding agent a | 3.5 | 3.5 | 3.5 | 3.5 | 3.0 |
| | | Expanding agent b | 0 | 0 | 0 | 0 | 0 |
| | | Expanding agent c | 0 | 0 | 0 | 0 | 0 |
| | pH adjusting agent | pH adjusting agent a | 0 | 0 | 0 | 0 | 0 |
| | | pH adjusting agent b | 0.9 | 0.9 | 0.9 | 0.9 | 0.9 |
| | Preservative | Sorbic acid | 0.2 | 0.2 | 0.2 | 0.2 | 0.2 |

| | | | | | |
|---|---|---|---|---|---|
| Dextrin | 0 | 0 | 0 | 0 | 0 |
| Trehalose | 1.7 | 1.7 | 1.7 | 1.7 | 1.5 |
| Alginic acid ester | 0.42 | 0 | 0 | 0 | 0 |
| Raw gelatin | 0 | 0 | 0 | 8.5 | 7.5 |
| Other solid raw ingredients | 5.0 | 5.0 | 5.0 | 5.0 | 5.0 |
| Total amount of raw ingredients | 99.4 | 99.0 | 96.5 | 96.0 | 97.7 |
| Total moisture content in raw ingredients | 37.1 | 37.1 | 36.9 | 37.5 | 38.8 |

| | | | | | |
|---|---|---|---|---|---|
| Expanding agents in raw ingredients [% by mass] | 2.61 | 2.62 | 2.68 | 2.70 | 2.27 |
| Cereals in raw ingredients [% by mass] | 15.6 | 15.7 | 13.5 | 13.5 | 18.4 |

| | | |
|---|---|---|
| Dough | Moisture content in dough [% by mass] | 43 to 47 |
| Pet food | Moisture content in product [% by mass] | 28 to 29 |

| Crude protein content [% by mass] | Approx- | Approx- | Approx- | Approx- | Approx- |
|---|---|---|---|---|---|
| | imately | imately | imately | imately | imately |
| | 24 | 24 | 23 | 22 | 23 |
| pH of food granules | 5.0 to 5.5 | | | | |
| Evaluation (hardness) | Approx- | Approx- | Approx- | Approx- | Approx- |
| | imately | imately | imately | imately | imately |
| | 50 | 55 | 60 | 65 | 65 |

As shown from the results listed in Table 1, regardless of the fact that each pet food obtained in Examples 1 to 10 had the same high level of the amount of proteins as the proteins of Reference Example 1, considerably softer physical properties than those of Reference Example 1 were obtained. Further, since each pet food of Examples 1 to 10 contained sorbic acid serving as a preservative exhibiting effects in a region of a pH of 6.5 or less, the storability thereof was also excellent.

Particularly, when Example 2 was compared to Example 6, the pet food of Example 2 obtained by using an acid component coated with fats and oils had excellent foamability, the food granules were greatly swollen, and thus the hardness was decreased compared to the pet food of Example 6 obtained by using an uncoated acid component.

Further, when Example 6 was compared to Example 7, it was confirmed that the softness was increased by adding alginic acid ester.

1. A method of producing pet food comprising:
a process of heating and foaming dough comprising an expanding agent, a preservative, and a pH adjusting agent to produce food granules containing animal-derived raw ingredients and having a crude protein content of 10% to 35% by mass, a moisture content of 20% to 35% by mass, and a pH of 6.5 or less.

2. The method of producing pet food according to claim 1,
wherein the preservative comprises at least one selected from the group consisting of sorbic acid and potassium sorbate.

3. The method of producing pet food according to claim 1,
wherein the pH adjusting agent is in the form of granules, and the granules being an acid component which is in a solid state at room temperature being coated with fats and oils which are in a solid state at room temperature.

4. The method of producing pet food according to claim 1,
wherein the content of the expanding agent is in a range of 1% to 4% by mass based on the total amount of raw ingredients in the dough.

5. The method of producing pet food according to claim 1,
wherein the dough contains cereals, and
the content of the cereals is in a range of 6% to 44% by mass based on the total amount of raw ingredients in the dough.

6. The method of producing pet food according to claim 1,
wherein alginic acid ester is further mixed into the dough.
